(19) United States
(12) Patent Application Publication
(10) Pub. No.: US 2025/0392859 A1
(43) Pub. Date: Dec. 25, 2025

(54) IMAGING APPARATUS

(71) Applicant: Panasonic Intellectual Property Management Co., Ltd., Osaka (JP)

(72) Inventor: Hiroki KASUGAI, Osaka (JP)

(73) Assignee: Panasonic Intellectual Property Management Co., Ltd., Osaka (JP)

(21) Appl. No.: 19/243,810

(22) Filed: Jun. 20, 2025

(30) Foreign Application Priority Data
Jun. 24, 2024 (JP) 2024-101137

(51) Int. Cl. H04R 3/00; G06F 3/16; G11B 27/10

(52) U.S. Cl. CPC H04R 3/00; G06F 3/162; G11B 27/10; H04R 2430/01

(57) ABSTRACT

An imaging apparatus includes: an image sensor; a sound input interface that inputs a first input sound; a first signal processor that performs first amplification conversion on the first input sound to generate a first audio signal; a second signal processor that performs second amplification conversion on the first input sound to generate a second audio signal; an audio processor that combines the first and second audio signals to generate first audio data in a predetermined data format; and a receiver that connects with an external sound collection apparatus for communication to receive third and fourth audio signals therefrom. The third and fourth audio signals respectively indicate results of third and fourth amplification conversion performed on second input sound in the sound collection apparatus. The audio processor combines the third and fourth audio signals received from the receiver to generate second audio data in the predetermined data format.

### TECHNICAL FIELD

The present disclosure relates to an imaging apparatus that performs a recording operation in a predetermined data format such as a float format.

### BACKGROUND ART

JP 63-282800 A discloses a data processing device that suitably performs arithmetic processing on floating point data in order to process an audio signal. This data processing device is provided with a significand part register and an exponent part register that store a significand part and an exponent part of floating point data, respectively. The data processing device performs arithmetic processing on an audio signal that is fixed point data of two left and right channels to create floating point data.

### SUMMARY

The present disclosure provides an imaging apparatus capable of facilitating to obtain audio data indicating a sound collection result in a predetermined data format.

An imaging apparatus according to the present disclosure includes including: an image sensor that captures a subject image to generate image data; a sound input interface that inputs a first input sound; a first signal processor that performs first amplification conversion on the first input sound to generate a first audio signal; a second signal processor that performs second amplification conversion on the first input sound to generate a second audio signal, the second amplification conversion being different from the first amplification conversion; an audio processor that combines the first and second audio signals to generate first audio data indicating a sound collection result of the first input sound in a predetermined data format; and a receiver that connects with an external sound collection apparatus for communication to receive third and fourth audio signals from the sound collection apparatus. The third audio signal indicates a result of third amplification conversion performed on second input sound in the sound collection apparatus. The fourth audio signal indicates a result of fourth amplification conversion performed on the second input sound in the sound collection apparatus, the fourth amplification conversion being different from the third amplification conversion. The audio processor combines the third and fourth audio signals received from the receiver to generate second audio data indicating a sound collection result of the second input sound in the predetermined data format.

According to the imaging apparatus of the present disclosure, it is possible to facilitate to obtain audio data indicating a sound collection result in a predetermined data format.

### BRIEF DESCRIPTION OF THE DRAWINGS

FIG. 1 is a diagram for explaining an imaging system according to a first embodiment of the present disclosure;

FIG. 2 is a diagram illustrating a configuration of a digital camera in the imaging system;

FIG. 3 is a diagram exemplifying a circuit configuration for float recording in the digital camera according to the first embodiment;

FIG. 4 is a diagram illustrating a configuration of a sound collection apparatus in the imaging system;

FIG. 5 is a flowchart exemplifying a setting operation of the digital camera in the imaging system of the first embodiment;

FIG. 6A to 6F are waveform diagrams for explaining a float recording operation in the imaging system;

FIG. 7 is a diagram for explaining a data structure of a float format;

FIG. 8 is a diagram for explaining the imaging system according to a second embodiment; and

FIG. 9 is a diagram illustrating a display example in the digital camera according to a variation.

### DETAILED DESCRIPTION

Hereinafter, embodiments will be described in detail with reference to the drawings as appropriate. However, detailed description of an already well-known matter and overlapping description for substantially the same configuration may be omitted. Note that the accompanying drawings and description below are provided to enable those skilled in the art to sufficiently understand the present disclosure, and these are not intended to limit the subject matter described in the claims.

### First Embodiment

### 1. Configuration

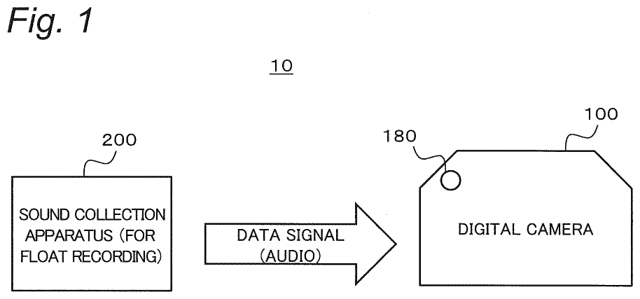

The imaging system according to a first embodiment of the present disclosure will be described with reference to FIG. 1.

### 1-1. System Overview

As illustrated in FIG. 1, an imaging system 10 according to the present embodiment includes a digital camera 100 and a sound collection apparatus 200, for example. In the present system 10, the digital camera 100 and the sound collection apparatus 200 are connected by wireless communication such as Bluetooth or by wired communication such as USB.

The present system 10 realizes float recording using the sound collection apparatus 200 in moving image shooting by the digital camera 100, for example. The float recording is a recording function capable of keeping resolution of each sound from relatively larger sound to smaller sound by a predetermined data format such as a float format.

In realizing such float recording, the imaging system 10 according to the present embodiment utilizes a calculation function of the digital camera 100 to adopt a simple configuration in the sound collection apparatus 200. According to the present system 10, the user of the digital camera 100 can facilitate to obtain a recording result of a high dynamic range and high accuracy in moving image shooting by preparing the sound collection apparatus 200 having a simple configuration, for example.

Furthermore, the present system 10 also enables float recording by a sound collecting means such as a microphone 180 built in the digital camera 100. The present system 10 provides the user with such various sound collecting means to facilitate use of audio capturing in the digital camera 100. Hereinafter, a configuration of the digital camera 100 and the sound collection apparatus 200 in the present system 10 will be described.

### 1-2. Configuration of Digital Camera

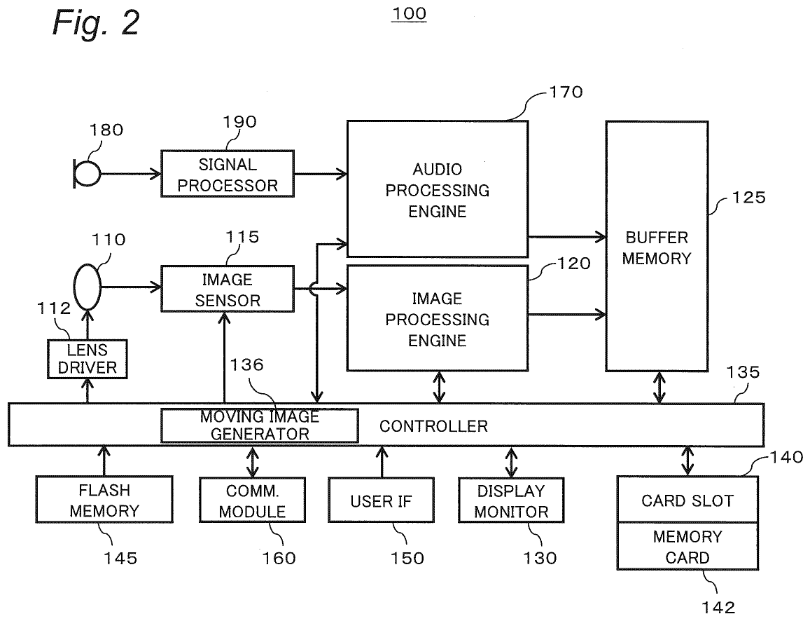

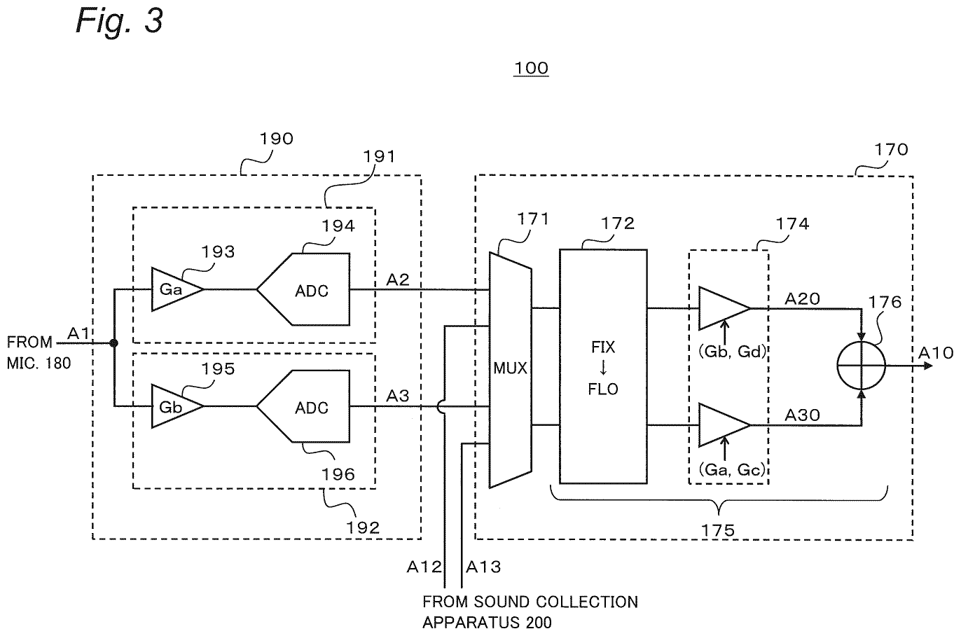

A configuration of the digital camera 100 in the present embodiment will be described with reference to FIGS. 2 and 3.

FIG. 2 is a diagram illustrating a configuration of the digital camera 100 according to the present embodiment. The digital camera 100 according to the present embodiment includes an image sensor 115, an image processing engine 120, a display monitor 130, and a controller 135. Furthermore, the digital camera 100 includes a buffer memory 125, a card slot 140, a flash memory 145, a user interface 150, a communication module 160, an audio processing engine 170, the microphone 180, and a signal processor 190. In addition, the digital camera 100 includes an optical system 110 and a lens driver 112, for example.

The optical system 110 includes a focus lens, a zoom lens, an optical image stabilizer (OIS), an aperture, a shutter, and the like. The focus lens is a lens for changing the focus state of the subject image formed on the image sensor 115. The zoom lens is a lens for changing the magnification of the subject image formed by the optical system. Each of the focus lenses and the like includes one or more lenses.

The lens driver 112 drives a focus lens and the like in the optical system 110. The lens driver 112 includes a motor, and moves a focus lens along an optical axis of the optical system 110 based on control of the controller 135. The configuration for driving the focus lens in the lens driver 112 can be implemented with a DC motor, a stepping motor, a servo motor, an ultrasonic motor, or the like.

The image sensor 115 captures a subject image formed via the optical system 110 to generate imaging data. The imaging data is image data indicating an image captured by the image sensor 115. The image sensor 115 generates image data for a new frame at a predetermined frame rate (e.g., 30 frames/second). A generation timing of imaging data and electronic shutter operation in the image sensor 115 are controlled by the controller 135. As the image sensor 115, various image sensors such as a CMOS image sensor, a CCD image sensor, or an NMOS image sensor can be used.

The image sensor 115 performs imaging operations of a moving image and a still image, an imaging operation of a through image, and the like. The through image is mainly a moving image, and is displayed on the display monitor 130 in order to allow the user to determine composition for capturing a still image, for example. Each of the through image, the moving image, and the still image is an example of the captured image in the present embodiment. The image sensor 115 is an example of an image sensor in the present embodiment.

The image processing engine 120 performs various kinds of processing on the imaging data output from the image sensor 115 to generate image data, or performs various kinds of processing on the image data to generate images to be displayed on the display monitor 130. Various kinds of processing include white balance correction, gamma correction, YC conversion processing, electronic zoom processing, compression processing, expansion processing, and the like, but are not limited to these. The image processing engine 120 may be configured with a hard-wired electronic circuit, or may be configured with a microcomputer, a processor, or the like using a program.

The display monitor 130 is an example of a display that displays various kinds of information. For example, the display monitor 130 displays an image (through image) indicated by image data which is captured by the image sensor 115 and on which image processing by the image processing engine 120 is performed. In addition, the display monitor 130 displays a menu screen or the like for a user to make various settings for the digital camera 100. The display monitor 130 can include a liquid crystal display device or an organic EL device, for example.

The user interface 150 is a general term for hard keys such as operation buttons and operation levers provided on the exterior of the digital camera 100, and receives operations by a user. For example, the user interface 150 includes a release button, a mode dial, a touch panel, a cursor button, and a joystick. When receiving operation by the user, the user interface 150 transmits an operation signal corresponding to user operation to the controller 135.

The controller 135 integrally controls entire operation of the digital camera 100. The controller 135 includes a CPU and the like, and the CPU executes a program (software) to realize a predetermined function. For example, the controller 135 functions as a decoder that decodes a signal received from the communication module 160 or a moving image generator 136 that controls an encoder for video and audio to generate a moving image file.

The decoder does not need to be realized by a function of the controller 135, and may be incorporated in the communication module 160, for example. The moving image generator 136 may be realized by cooperation with various ones of the engines 120 and 170 without limitation to a function of the controller 135, or may be implemented by a circuit configuration. The controller 135 may include, instead of the CPU, a processor including a dedicated electronic circuit designed to realize a predetermined function. That is, the controller 135 can be realized by various processors such as a CPU, an MPU, a GPU, a DSP, an FPGA, and an ASIC. The controller 135 may include one or more processors. The controller 135 may include one semiconductor chip together with the image processing engine 120 and the like.

The buffer memory 125 is a recording medium that functions as a work memory of the image processing engine 120 and the controller 135. The buffer memory 125 is implemented by a dynamic random-access memory (DRAM) or the like. The flash memory 145 is a non-volatile recording medium. Although not illustrated, the controller 135 may include various internal memories, and e.g., may incorporate a ROM. The ROM stores various programs to be executed by the controller 135. The controller 135 may incorporate a RAM that functions as a work area of a CPU.

The card slot 140 is a means into which a detachable memory card 142 is inserted. The card slot 140 can connect the memory card 142 electrically and mechanically. The memory card 142 is an external memory including a recording element such as a flash memory inside. The memory card 142 can store data such as image data generated by the image processing engine 120.

The communication module 160 is a module (circuit) connected to an external device such as the sound collection apparatus 200 in accordance with a predetermined communication standard such as Bluetooth Low Energy (BLE). For example, the communication module 160 performs wireless communication of an audio signal in the LE Audio standard. Communication by the communication module 160 is not limited to wireless communication, and may be wired communication. The communication standard of the communication module 160 is not particularly limited, and may be, e.g., USB, HDMI (registered trademark), IEEE 802.11, Wi-Fi, or the like. The communication module 160 is an example of a receiver of the digital camera 100 in the present embodiment, and may be an example of a transmitter or a communication interface of the digital camera 100.

The audio processing engine 170 performs various audio processing on an audio signal acquired from the outside or inside of the digital camera 100 to generate audio data as a processing result, for example. The audio processing engine 170 is an example of an audio processor in the present embodiment. The audio processing engine 170 may be configured integrally with one or both of the image processing engine 120 and the controller 135.

The microphone 180 is an example of a sound input interface including one or more microphone elements built in the digital camera 100, for example. The microphone 180 inputs an input sound of one channel or a plurality of channels to the digital camera 100. For example, the microphone 180 outputs an analog signal (which is an electric signal) indicating captured audio to the signal processor 190. The microphone 180 that is externally attached may be used for the digital camera 100.

The digital camera 100 may include a connector such as a terminal connected to an external microphone as a sound input interface alternatively or additionally to the built-in microphone 180. The digital camera 100 may include an accessory shoe such as a hot shoe or a cold shoe, a connection plug, or the like as such a connector.

The signal processor 190 is a signal processing circuit that performs signal processing such as analog/digital (A/D) conversion on an analog signal from the microphone 180, for example. The signal processor 190 outputs an audio signal of a signal processing result to the audio processing engine 170. The signal processor 190 includes a circuit configuration for float recording in the digital camera 100.

### 1-2-1. Circuit Configuration of Float Recording

A configuration of the signal processor 190 and the like for float recording in the digital camera 100 according to the present embodiment will be described with reference to FIG. 3.

For example, as a circuit configuration for float recording, the signal processor 190 of the digital camera 100 includes a high (H) level signal processor 191 and a low (L) level signal processor 192 for each input sound of one channel as exemplified in FIG. 3.

For example, as illustrated in FIG. 3, the signal processors 191 and 192 include a signal processing circuit including amplifiers 193 and 195 and A/D converters 194 and 196, respectively. In each of the signal processors 191 and 192, different gains Ga and Gb are set so as to share the entire dynamic range of the digital camera 100.

For the amplifier 193 of the H level signal processor 191, the gain Ga is set so as to reduce influence of circuit noise from the viewpoint of accurately capturing input sound having a relatively smaller volume, for example. For example, the gain Ga is larger than the gain Gb of the L level signal processor 192. In this manner, the H level signal processor 191 has a dynamic range on the small volume side in the sound collection apparatus 200.

For the amplifier 195 of the L level signal processor 192, the gain Gb is set so as to reduce saturation distortion of a signal waveform from the viewpoint of accurately capturing input sound having a relatively large volume, for example. In this manner, in the sound collection apparatus 200, the L level signal processor 192 has a dynamic range on the large volume side.

For example, the dynamic range of the H level signal processor 191 and the dynamic range of the L level signal processor 192 are continuous, and may partially overlap. The A/D converters of the signal processors 191 and 192 have a common circuit characteristic such as resolution. One or a plurality of the signal processors 191 and 192 may be integrated on an IC chip.

As illustrated in FIG. 3, the audio processing engine 170 of the present embodiment includes a data conversion unit 172, an amplification unit 174, and a combining unit 176 as a float recording processor 175, for example. The float recording processor 175 is a functional configuration that performs arithmetic processing for realizing float recording (details will be described later).

The digital camera 100 of the present embodiment further includes a multiplexer 171 in the audio processing engine 170, for example. The multiplexer 171 selectively switches between input of audio signals A2 and A3 from the signal processors 191 and 192 of the digital camera 100 and input of audio signals A12 and A13 from the sound collection apparatus 200. The multiplexer 171 may be implemented by a circuit configuration, or may be realized as a functional configuration of the audio processing engine 170 or the controller 135.

### 1-3. Configuration of Sound Collection Apparatus

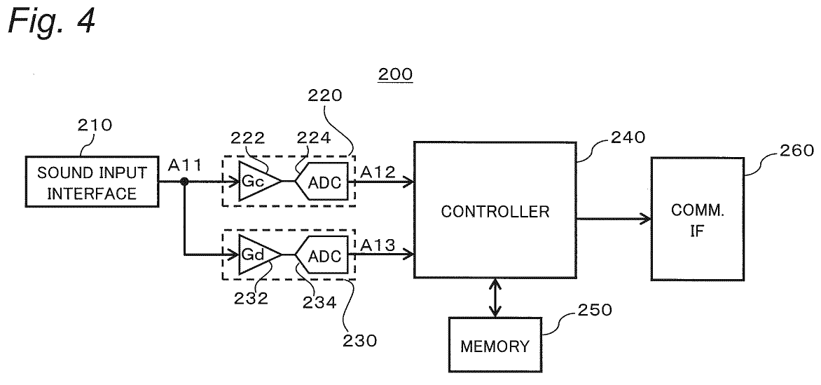

A configuration of the sound collection apparatus 200 according to the present embodiment will be described with reference to FIG. 4. FIG. 4 illustrates a configuration of the sound collection apparatus 200 in the present system.

As illustrated in FIG. 4, the sound collection apparatus 200 of the present embodiment includes a sound input interface 210, a plurality of signal processors 220 and 230, a controller 240, a memory 250, and a communication interface 260, for example. The sound collection apparatus 200 is a device that performs sound collection for float recording using an external microphone, for example.

The sound input interface 210 includes an input terminal connected to one or more external microphones, for example. The sound input interface 210 acquires input sound of one channel by inputting, to the sound collection apparatus 200, an analog signal indicating sound collected with one monaural microphone, for example.

The sound input interface 210 is connected to the H level signal processor 220 and the L level signal processor 230 that are parallel to an input sound of one channel. The sound input interface 210 may acquire the input sound of multiple channels, and may be stereo input, for example. The sound collection apparatus 200 may be configured integrally with a microphone. In this case, the sound input interface 210 may be a microphone of the sound collection apparatus 200.

For example, the signal processors 220 and 230 include amplifiers 222 and 232 and A/D converter 224 and 234, respectively, similarly to the signal processors 191 and 192 (FIG. 3) of the digital camera 100. To a plurality of the signal processors 220 and 230, different gains Gc and Gd are set so as to share the entire dynamic range of the sound collection apparatus 200.

Similarly to the H level signal processor 191 of the digital camera 100, for example, the H level signal processor 220 has the relatively large gain Gc in the amplifier 222 and has a dynamic range on the small volume side in the sound collection apparatus 200.

Similarly to the L level signal processor 192 of the digital camera 100, for example, the L level signal processor 230 has the relatively small gain Gd in the amplifier 232 and has a dynamic range on the large volume side in the sound collection apparatus 200.

For example, the dynamic range of the H level signal processor 220 and the dynamic range of the L level signal processor 230 are continuous, and may be partially overlapped. The A/D converters of the signal processors 220 and 230 have a common circuit characteristic such as resolution. One or more of the signal processors 220 and 230 may be integrated on an IC chip.

The controller 240 controls overall operation of the sound collection apparatus 200, for example. For example, the controller 240 includes a CPU or an MPU that implements a predetermined function in cooperation with software. For example, the controller 240 serves as an encoder that encodes a signal transmitted from the communication interface 260.

The encoder does not need to be realized by a function of the controller 240, and may be incorporated in the communication interface 260, for example. The controller 240 may be a hardware circuit such as a dedicated electronic circuit or a reconfigurable electronic circuit designed to implement a predetermined function. The controller 240 may include various semiconductor integrated circuits such as a CPU, an MPU, a microcomputer, a DSP, an FPGA, and an ASIC.

The memory 250 includes a ROM and a RAM that store a program and data necessary for implementing a function of the sound collection apparatus 200. The memory 250 stores information indicating each gain in the signal processors 220 and 230, for example.

The communication interface 260 is a module (circuit) that is connected to an external device according to a predetermined communication standard such as BLE. For example, the communication interface 260 performs wireless communication of an audio signal in the LE Audio standard. Communication by the communication interface 260 is not limited to wireless communication, and may be wired communication. The communication standard of the communication interface 260 is not particularly limited, and may be, for example, USB, IEEE 802.11, Wi-Fi, or the like. The communication interface 260 is an example of a transmitter of the sound collection apparatus 200 in the present embodiment, and may be an example of a receiver of the sound collection apparatus 200.

### 2. Operation

Operation of the imaging system 10 and the digital camera 100 configured as described above will be described below.

For example, at the time of shooting a moving image without using the sound collection apparatus 200, the digital camera 100 of the present system 10 acquires input sound such as an environmental sound in a shooting environment from the built-in microphone 180 or the like. The H/L level signal processors 191 and 192 (FIG. 3) of the digital camera 100 performs two types of amplification conversion on an input audio signal A1. For example, the float recording processor 175 of the digital camera 100 receives audio signals A2 and A3 indicating results of two types of amplification conversion as described above, and executes float recording processing that is arithmetic processing for performing float recording (details will be described later).

As described above, the digital camera 100 according to the present embodiment generates audio data A10 of float recording by a sound collecting means having an internal configuration including the signal processors 191 and 192, and the like. In addition to such a sound collecting means, the present system 10 (FIG. 1) includes a sound collecting means that enables float recording at the time of shooting a moving image or the like using the sound collection apparatus 200 outside the digital camera 100.

In the present system 10, the sound collection apparatus 200 (FIG. 4) acquires an input audio signal A11 from the sound input interface 210, performs two types of amplification conversion by the H/L level signal processors 220 and 230, and transmits an amplification conversion result from the communication interface 260 to the digital camera 100. For example, the digital camera 100 inputs audio signals A12 and A13 as a result of amplification conversion in the sound collection apparatus 200 to the float recording processor 175 instead of the case of the audio signals A2 and A3 by the internal configuration described above, and performs float recording processing according to the sound collection apparatus 200.

As described above, the present system 10 can facilitate the user to use float recording by adopting the plurality of systems of sound collecting means in the digital camera 100. Hereinafter, details of operation of the digital camera 100 in the present system 10 will be described.

### 2-1. Setting Operation of Float Recording

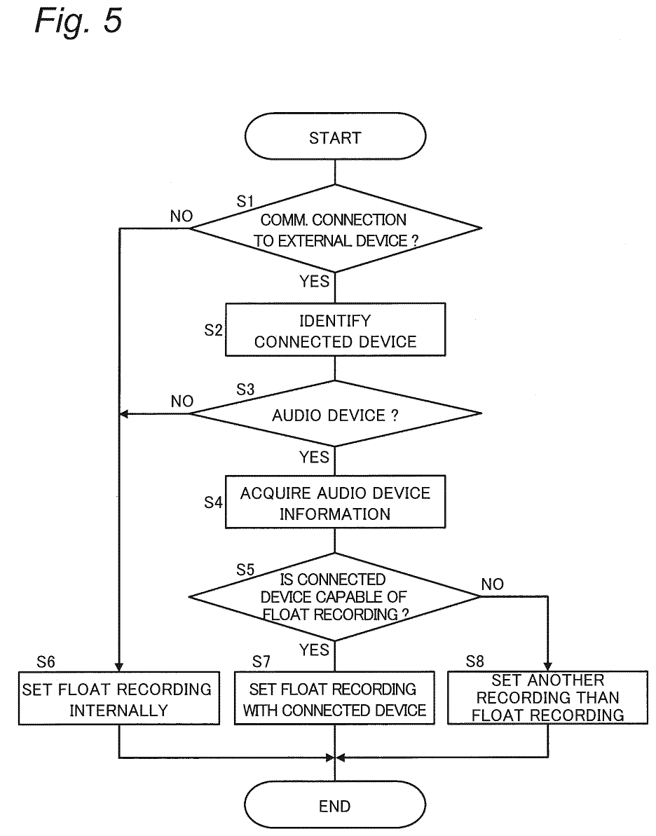

Operation of switching setting of the sound collecting means as described above in the digital camera 100 according to the present embodiment will be described with reference to FIG. 5.

FIG. 5 is a flowchart exemplifying setting operation of the digital camera 100 in the present system 10. The processing illustrated in the flowchart of FIG. 5 is executed by the controller 135 of the digital camera 100 at a predetermined cycle, for example.

First, the controller 135 of the digital camera 100 detects a communication connection of an external device to the digital camera 100, and determines whether or not the external device is connected to the digital camera 100 in a manner communication can be performed (S1). The determination in Step S1 is made by detecting a connection state of various ones of the communication modules 160 in the digital camera 100 or a connector such as an accessory shoe or a connection plug.

When determining that the external device is not connected to the digital camera 100 (NO in S1), the controller 135 sets the digital camera 100 so that float recording can be started by an internal configuration such as the microphone 180 and the signal processor 190 (S6).

For example, in Step S6, the controller 135 sets the multiplexer 171 so that the audio signals A2 and A3 obtained by the signal processors 191 and 192 of the digital camera 100 are input to the float recording processor 175 (FIG. 3). The controller 135 sets the gains Ga and Gb of the signal processors 191 and 192 in the amplification unit 174 of the float recording processor 175.

On the other hand, when determining that the external device is connected to the digital camera 100 (YES in S1), the controller 135 identifies the connected external device and a form of the communication connection (S2). For example, in Step S2, the controller 135 identifies a type of the external device (for example, an audio device, a lighting device, an information terminal, an external storage device, or the like) or a type of communication connection by information communication with the connected device.

For example, the controller 135 determines whether or not the connected device is an audio device based on a recognition result of the connected device (S3). For example, the audio device includes the sound collection apparatus 200 for float recording in the present system 10 or another sound collection apparatus, and may be an external microphone. For example, in the case of USB communication, the determination in Step S3 may be “NO” when the digital camera 100 is not a host in the communication connection, and then the processing may proceed to Step S6.

When the connected device is not an audio device (NO in S3), the controller 135 performs setting of the digital camera 100 for float recording by the internal configuration similarly to the case of “NO” in Step S1 (S6).

On the other hand, when the connected device is an audio device (YES in S3), the controller 135 acquires audio device information on the connected device via information communication with the device via the communication module 160 or various connectors, for example (S4). For example, the audio device information includes whether or not the device can execute float recording, gain information, latency information, a sampling rate, and the like. The audio device information may include an audio class in the case of USB communication.

In Step S4, the controller 135 of the digital camera 100 receives the audio device information from the connected device via the communication module 160 or the connector, for example. The audio device information may be stored in the flash memory 145 or the like in association with identification information of the audio device in advance in the digital camera 100. In this case, the controller 135 may perform the processing in Step S4 by receiving identification information from the connected audio device and referring to information stored in the flash memory 145.

The controller 135 determines whether or not the connected audio device can execute float recording based on the acquired audio device information (S5). For example, when the connected audio device is the sound collection apparatus 200 (FIG. 4) for float recording in the present system 10, the determination in Step S5 is “YES”.

When the connected audio device can execute float recording (YES in S5), the controller 135 sets the digital camera 100 so that float recording using the audio device can be started (S7).

For example, in Step S7, the controller 135 sets the multiplexer 171 so that two types of the audio signals A12 and A13 obtained by the signal processors 220 and 230 of the sound collection apparatus 200 are input to the float recording processor 175 (FIG. 3). The controller 135 sets the gains Gc and Gd of the signal processors 220 and 230 in the amplification unit 174 of the float recording processor 175.

On the other hand, when the connected audio device cannot execute float recording (NO in S5), the controller 135 sets the digital camera 100 so that the audio device can be used to start recording operation different from float recording, for example (S8).

For example, in Step S8, the controller 135 sets the audio processing engine 170 so that one type of audio signal from the connected sound device is input instead of two types of the audio signals A12 and A13 from the sound collection apparatus 200. Furthermore, the controller 135 sets the audio processing engine 170 so as to generate audio data in a fixed format or the like without performing float recording processing on the audio signal.

The controller 135 ends the processing illustrated in FIG. 5 by performing setting of any of Steps S6, S7, and S8.

According to the above processing, the digital camera 100 according to the present embodiment can switch between setting of float recording by an internal configuration (S6) and setting of float recording by an external configuration (S7) and selectively execute any of the float recordings.

The digital camera 100 according to the present embodiment can execute recording operation that is not only float recording (S8). For example, when a sound collection apparatus that does not support float recording is connected (NO in S5), the digital camera 100 according to the present embodiment may generate audio data that is not in a float format based on a sound collection result of such a sound collection apparatus. For example, when an external microphone of analog output is connected to the digital camera 100, the controller 135 may perform the setting of Step S6 such that an input audio signal from the microphone is input to the signal processors 191 and 192 to perform float recording by an internal configuration.

In the above description, the example in which setting (S6 to S8) of float recording and the like is performed according to a connection state of an external device to the digital camera 100 is described. The digital camera 100 according to the present embodiment is not limited to the above example, and may perform the setting (S6 to S8) of float recording in accordance with user operation on the user interface 150, for example. For example, in a setting menu or the like of the digital camera 100, the controller 135 may receive user operation for selecting any of the recording settings in Steps S6 to S8.

### 2-2. Float Recording Operation

Details of float recording operation in the present system 10 will be described with reference to FIGS. 3 to 7.

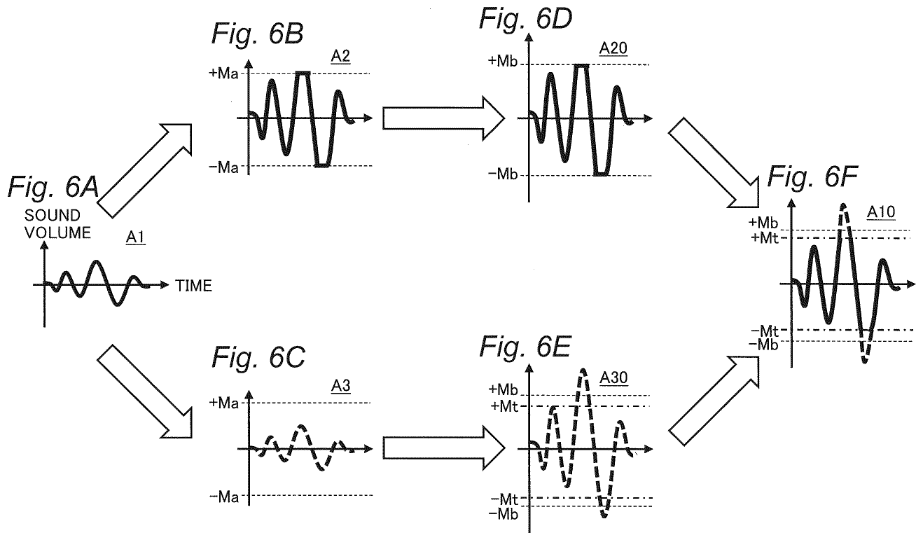

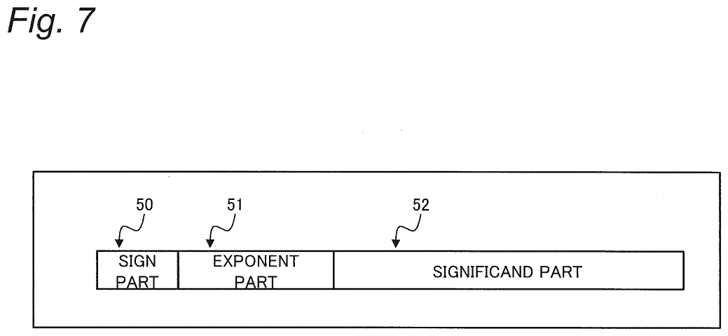

FIGS. 6A to 6F are waveform diagrams for explaining the float recording operation in the present system 10. FIG. 7 is a diagram for explaining a data structure of a float format.

FIGS. 6A to 6F illustrate an operation example in the case where setting of float recording is performed by an internal configuration of the digital camera 100 (S6 in FIG. 5). In this case, the input audio signal A1 indicating input sound acquired by the microphone 180 of the digital camera 100 is input to the H level signal processor 191 and the L level signal processor 192 as illustrated in FIG. 3, for example. An example of the input audio signal A1 is illustrated in FIG. 6A. In the waveform diagram of FIG. 6A, the horizontal axis represents time and the vertical axis represents sound volume (the same applies hereinafter).

In the H level signal processor 191, the amplifier 193 amplifies the input audio signal A1 with the gain Ga set to be relatively large. The A/D converter 194 performs A/D conversion for converting an amplification result of the input audio signal A1 in the amplifier 193 from an analog signal to a digital signal, and generates an H level audio signal A2. Such processing of the input audio signal A1 in the H level signal processor 191 is an example of first amplification conversion in the present embodiment.

FIG. 6B exemplifies the H level audio signal A2 obtained from the input audio signal A1 in the example of FIG. 6A. In the example of FIG. 6B, waveform distortion occurs in the H level audio signal A2 in the vicinity of a maximum value Ma that can be output by each of the signal processors 191 and 192. On the other hand, according to the H level audio signal A2, a signal-to-noise ratio is higher as the gain Ga is larger.

In the L level signal processor 192, the amplifier 195 amplifies the input audio signal A1 with the gain Gb set to be relatively small. The A/D converter 196 performs A/D conversion from an analog signal to a digital signal for an amplification result of the input audio signal A1 in the amplifier 195 to generate the L level audio signal A3. Such processing of the input audio signal A1 in the L level signal processor 192 is an example of second amplification conversion in the present embodiment.

FIG. 6C exemplifies the L level audio signal A3 obtained from the input audio signal A1 in the example of FIG. 6A. The L level audio signal A3 is less likely to cause signal waveform distortion than the H level audio signal A2. On the other hand, a signal-to-noise ratio is lower as the gain Gb is smaller.

The audio signals A2 and A3 generated by the signal processors 191 and 192 are digital signals in a fixed format, indicating sound as a digital value in a predetermined dynamic range (±Ma) and resolution. The present system 10 performs remaining arithmetic processing for float recording on the two types of the audio signals A2 and A3 generated as described above in the digital camera 100.

For example, in the digital camera 100, the multiplexer 171 outputs the audio signals A2 and A3 from the H/L level signal processors 191 and 192 in the digital camera 100 to the float recording processor 175 according to the setting of the controller 135 in Step S6 in FIG. 5.

In the digital camera 100 according to the present embodiment, as illustrated in FIG. 3, the float recording processor 175 of the audio processing engine 170 performs calculation corresponding to each of the data conversion unit 172, the amplification unit 174 and the combining unit 176 to execute float calculation processing, for example.

In the audio processing engine 170 of the digital camera 100, first, the data conversion unit 172 converts each of the audio signals A2 and A3, received from the sound collection apparatus 200, from audio data of the fixed format to audio data of a float format. A data structure of the float format will be described with reference to FIG. 7.

The float format is a data format in which a data value is represented by a floating point type. As illustrated in FIG. 7, the data structure of the float format includes a sign part 50, an exponent part 51, and a significand part 52, for example.

The sign part 50 is a part indicating a positive or negative sign in a bit string indicating the data structure of the float format, for example. The sign part 50 may be appropriately omitted from the data structure of the float format.

The exponent part 51 is a part indicating an exponent to be used in exponent notation of the data value in the bit string of the float format. The exponent notation has a base number of two as a binary number, for example. According to the exponent part 51, a level of sound volume corresponding to a position of a decimal point in such notation is managed.

The significand part 52 is a part indicating a significant figure of the data value in the bit string of the float format. For example, as the number of bits allocated to the significand part 52 is larger, the resolution of audio data is higher.

In the float format, a predetermined amount of bit numbers defining the bit string is allocated and set in advance among the sign part 50, the significand part 52, and the exponent part 51. For example, in 32 bit float recording, the sign part 50 has 1 bit, the exponent part 51 has 8 bits, and the significand part 52 has 23 bits. According to audio data of such a float format, resolution corresponding to the number of bits of the significand part 52 can be obtained over a sound volume level corresponding to the number of bits of the exponent part 51.

For example, the audio processing engine 170 serving as the data conversion unit 172 sequentially calculates a value of the exponent part 51 and a value of the significand part 52 so as to normalize a data value indicated by the H level audio signal A2 for each time in a floating point type, and generates audio data of the float type. The audio processing engine 170 similarly performs normalization operation of the floating point type also for the L level audio signal A3 to generate audio data of the float format. The audio data generated as the above shows a larger sound volume as the value of the exponent part 51 is larger. For example, the normalization is performed by increasing the value of the exponent part 51 in turn until the most significant digit of the significand part 52 is no longer zero.

Returning to FIG. 3, in the audio processing engine 170, the amplification unit 174 performs amplification operation to offset a difference between the gains Ga and Gb based on gain information indicating the gains Ga and Gb of the amplifiers 193 and 195 in the sound collection apparatus 200, for example.

For example, in the audio processing engine 170, the amplification unit 174 calculates an H level audio data A20 so that a conversion result of the H level audio signal A2 into the float format is amplified by the lower gain Gb in floating point operation. Similarly, the amplification unit 174 calculates an L level audio data A30 so as to amplify, by the higher gain Ga, a conversion result of the L level audio signal A3.

FIG. 6D illustrates the H level audio data A20 calculated from the H level audio signal A2 in FIG. 6B. FIG. 6E illustrates the L level audio data A30 calculated from the L level audio signal A3 in FIG. 6C. According to the calculation of the amplification unit 174, as illustrated in FIGS. 6D and 6E, the magnitude of sound volume can be equalized between the H level audio data A20 and the L level audio data A30, for example.

Next, the combining unit 176 in the audio processing engine 170 generates audio data A10 of float recording by arithmetic processing of combining the H level audio data A20 and the L level audio data A30 by switching therebetween, for example. FIG. 6F illustrates the audio data A10 of float recording generated from the audio data A20 and A30 of FIGS. 6D and 6E.

For example, the combining unit 176 compares the magnitude (absolute value) of the L level audio data A30 with a predetermined threshold Mt, and in the case that the L level audio data A30 is equal to or more than the threshold Mt, adopts the L level audio data A30 as the audio data A10 of float recording. On the other hand, in the case that the L level audio data A30 is less than the threshold Mt, the combining unit 176 adopts the H level audio data A20 as the audio data A10 of float recording. For example, the threshold Mt is set in the vicinity of a value Mb corresponding to the maximum value Ma of output from each of the signal processors 191 and 192 or less in each piece of the audio data A20 and A30.

On the other hand, in the present system 10, when setting of float recording is performed by an external configuration of the digital camera 100 (S7 in FIG. 5), the multiplexer 171 outputs the audio signals A12 and A13 from the sound collection apparatus 200 to the float recording processor 175, for example. For example, the audio signals A12 and A13 are obtained by the controller 135 of the digital camera 100 appropriately decoding a data signal received from the sound collection apparatus 200, and are input to the multiplexer 171 after decoding.

In the sound collection apparatus 200 of the present system 10, as illustrated in FIG. 4, the input audio signal A11 indicating input sound acquired by the sound input interface 210 is input to each of the H level signal processor 220 and the L level signal processor 230.

In the H level signal processor 220, the amplifier 222 amplifies the input audio signal A11 with the gain Gc set to be relatively large. The A/D converter 224 performs A/D conversion on an amplification result of the input audio signal A11 in the amplifier 222 to generate the H level audio signal A12. Such processing of the H level signal processor 220 is an example of third amplification conversion in the present embodiment.

In the L level signal processor 230, the amplifier 232 amplifies the input audio signal A11 with the gain Gd set to be relatively small. The A/D converter 234 performs A/D conversion on an amplification result of the input audio signal A11 in the amplifier 232 to generate the L level audio signal A13. Such processing of the L level signal processor 230 is an example of fourth amplification conversion in the present embodiment.

In the present system 10, the float recording processor 175 of the digital camera 100 performs float recording processing on two types of the audio signals A12 and A13 generated by the sound collection apparatus 200 as described above, similarly to the audio signals A2 and A3 described above. At this time, in an amplification unit 173, the gains Gc and Gd according to gain information of the sound collection apparatus 200 are set to be offset by the controller 135 in Step S7 of FIG. 5, for example. With such float recording operation, the digital camera 100 of the present embodiment generates the audio data A10 of float recording for input sound of the sound collection apparatus 200.

During the float recording operation as described above, in the digital camera 100, the image sensor 115 performs imaging of each frame of a moving image, and the image processing engine 120 sequentially generates image data of each frame of the moving image. According to the digital camera 100 of the present embodiment, the controller 135 as the moving image generator 136 generates a moving image file by performing encoding or the like that sequentially associates audio data of float recording obtained as described above with image data of each frame, for example. The generated moving image file is recorded in the memory card 142 from the card slot 140, for example.

According to the above operation of the present system 10, when the user shoots a moving image, float recording can be performed in the digital camera 100, and avoiding recording accidents such as clipping or insufficient volume during shooting of the moving image can be facilitated, for example. Complicated labor such as adjustment of recording level setting performed by a conventional digital camera at the time of shooting a moving image can be saved, and the user can easily obtain a highly accurate sound collection result with concentrating on a composition of shooting of the moving image, for example.

According to the present system 10, the user can obtain audio data of float recording in the moving image file obtained as a result of shooting the moving image by the digital camera 100, for example. Accordingly, as compared with a case where equipment for performing float recording is separately prepared for example, it is possible to save labor for the user to perform editing such as replacing audio data of a sound collection result of the other equipment with audio data of the moving image file after shooting, and it is possible for the user to facilitate using float recording.

According to the float recording operation described above, in the present system 10, by the digital camera 100 alone, or by cooperation between the sound collection apparatus 200 and the digital camera 100, the audio data A10 of float recording that accurately shows each input sound can be obtained. For example, it is not necessary to provide an arithmetic circuit capable of performing floating point operation particularly in the sound collection apparatus 200, and thus a device configuration of the sound collection apparatus 200 can be simplified.

According to the processing of the combining unit 176, influence of signal distortion in the H level audio data A20 is easily avoided by using the L level audio data A30 for threshold determination. For example, as illustrated in FIGS. 6E and 6F, in a range of large sound volume that is enough to cause signal distortion in the H level audio data A20, the L level audio data A30 is adopted, and influence of the signal distortion can be reduced in the audio data A10 of float recording. For example, as illustrated in FIGS. 6D and 6F, a signal-to-noise ratio can be easily improved by adopting the H level audio data A20 as a sound collection result except for the large sound volume range.

The combining unit 176 may perform various arithmetic processing of combining the H level audio data A20 and the L level audio data A30, and a hysteresis may be provided in the threshold determination as described above, for example. For example, when the H level audio data A20 and the L level audio data A30 are frequently switched by threshold determination, the audio data may be temporarily fixed to the L level audio data A30. By such arithmetic processing, it is possible to reduce uncomfortable feeling on audibility in the audio data A10 of float recording.

For example, in the present embodiment, the combining unit 176 may perform arithmetic processing such as floating point operation of combining the H level audio data A20 and the L level audio data A30 at a predetermined combination ratio, instead of the arithmetic processing of combining the audio data A20 and A30 by switching therebetween. Also by such arithmetic processing, the digital camera 100 of the present embodiment can obtain the audio data A10 of float recording.

For example, the amplification unit 174 may correct an amplification factor by comparing the gains Ga and Gb indicated by gain information with a difference between both the audio signals A2 and A3, to perform the above-described amplification processing. According to this, a robust system can be obtained, which is not likely to affect the combining even when a difference in amplification factors may occur due to manufacturing variations of amplifiers or the like.

### 3. Review

As described above, in the present embodiment, the digital camera 100 as an example of the imaging apparatus includes the image sensor 115 as an example of an image sensor, the microphone 180 as an example of a sound input interface, the H level signal processor 191 as an example of a first signal processor, the L level signal processor 192 as an example of a second signal processor, the audio processing engine 170 as an example of an audio processor, and the communication module 160 as an example of a receiver. The image sensor 115 captures a subject image and generates image data. The microphone 180 receives a first input sound as the input audio signal A1. The H level signal processor 191 performs the first amplification conversion on the first input sound to generate the first audio signal A2. The L level signal processor 192 performs the second amplification conversion, which is different from the first amplification conversion, on the first input sound to generate the second audio signal A3. The audio processing engine 170 combines the first and second audio signals A2 and A3 to generate the first audio data A10a indicating a sound collection result of the first input sound in a float format as an example of a predetermined data format. The communication module 160 establishes a communication connection with the external sound collection apparatus 200, and receives the third and fourth audio signals A12 and A13 from the sound collection apparatus 200. The third audio signal A12 indicates a result of the third amplification conversion performed on the second input sound in the sound collection apparatus 200. The fourth audio signal A13 indicates a result of the fourth amplification conversion performed on the second input sound in the sound collection apparatus 200, the fourth amplification conversion being different from the third amplification conversion. The audio processing engine 170 combines the third and fourth audio signals A12 and A13 received from the communication module 160 to generate the second audio data A10b indicating a sound collection result of the second input sound in a float format, for example.

According to the digital camera 100 described above, float recording by an internal configuration of the digital camera 100 and float recording using the sound collection apparatus 200 can be performed, and the audio data A10 indicating a sound collection result can be easily obtained in a predetermined data format such as a float format.

In the present embodiment, the digital camera 100 further includes the moving image generator 136 that generates a moving image file by associating image data with the first or second audio data A10. The audio processing engine 170 selectively generates one of the first and second audio data A10 (see FIG. 3). By this, moving image shooting can be performed by switching sound collecting means for float recording inside and outside the digital camera 100, and float recording can be easily used in moving image shooting.

In the present embodiment, the digital camera 100 further includes the controller 135 that detects communication connection between the sound collection apparatus 200 and the communication module 160 and controls the audio processing engine 170. When the sound collection apparatus 200 connected to the communication module 160 can execute float recording and can transmit the third and fourth audio signals A12 and A13 (YES in S5), the controller 135 controls the audio processing engine 170 to generate the second audio data A10b based on the third and fourth audio signals A12 and A13 (S7). By this, float recording can be performed by the digital camera 100 using the sound collection apparatus 200 supporting float recording, and the user of the digital camera 100 can easily use float recording.

In the digital camera 100 of the present embodiment, when the sound collection apparatus 200 is not connected to the communication module 160 (NO in S1 or S3), the controller 135 controls the audio processing engine 170 to generate the first audio data A10a based on the first and second audio signals A2 and A3 (S6). By this, when the sound collection apparatus 200 for float recording is not used, float recording can be performed by an internal configuration of the digital camera 100, and the user of the digital camera 100 can easily use float recording.

In the digital camera 100 of the present embodiment, when the sound collection apparatus such as a sound device connected to the communication module 160 cannot transmit the third and fourth audio signals A12 and A13 (NO in S5), the controller 135 controls the audio processing engine 170 to generate the third audio data indicating a sound collection result of the second input sound in a format different from a float format based on the fifth audio signal received by the communication module 160 from the sound collection apparatus (S8). By this, when a sound collection apparatus that cannot perform float recording is used, recording can be performed in a format different from a float format, and the user can easily use the digital camera 100.

In the digital camera 100 according to the present embodiment, the H level signal processor 191 includes the first amplifier 193 that amplifies the first input sound with the first gain Ga, and the first A/D converter 194 that performs A/D conversion on an amplification result of the first amplifier 193 to generate the first audio signal A2. The L level signal processor 192 includes the second amplifier 195 that amplifies the first input sound with the second gain Gb smaller than the first gain Ga, and the second A/D converter 196 that performs A/D conversion on an amplification result of the second amplifier 195 to generate the second audio signal A3. By providing the digital camera 100 with such a circuit configuration of the signal processors 191 and 192, float recording by an internal configuration of the digital camera 100 can be performed. For example, in the audio data A10 as a recording result, a sound volume of a portion corresponding to the first audio signal A2 is equal to or more than a sound volume of a portion corresponding to the second audio signal A3.

In sound collection apparatus 200 of the present embodiment, in the third amplification conversion, the third amplifier 222 in which the third gain Gc is set amplifies the second input sound, and A/D converts the amplified second input sound to generate the third audio signal A12. In the fourth amplification conversion, the fourth amplifier 232 in which the fourth gain Gd smaller than the third gain Gc is set amplifies the second input sound, and A/D converts the amplified second input sound to generate the fourth audio signal A13. For example, in the second audio data A10b, a sound volume of a portion corresponding to the third audio signal A12 is equal to or more than a sound volume of a portion corresponding to the fourth audio signal A13. In this way, as a sound collection result of the present system 10, it is possible to obtain the audio data A10 of input sound accurately acquired in a wide dynamic range by using the audio signals A12 and A13.

In the digital camera 100 of the present embodiment, the audio processing engine 170 acquires gain information set in the third and fourth amplifiers 222 and 232 in the sound collection apparatus 200, and generates the second audio data A10 from the third and fourth audio signals A12 and A13 by using the gain information. The present system 10 can generate the audio data A10 of a sound collection result with high accuracy by using such gain information. For example, the audio processing engine 170 uses gain information to generate the audio data A10 as a sound collection result in such a manner that a difference between the gains Ga and Gb in the audio signals A2 and A3 is reduced. The audio processing engine 170 may acquire gain information by information communication with the sound collection apparatus 200 in the communication module 160.

In the present embodiment, the predetermined data format is a float format having the significand part 52 and the exponent part 51. The audio processing engine 170 generates the audio data A10 as a sound collection result such that the exponent part 51 is made larger as a sound volume of input sound is larger. In this way, the digital camera 100 according to the present embodiment can generate the audio data A10 as a sound collection result with high accuracy by using a float format.

### Second Embodiment

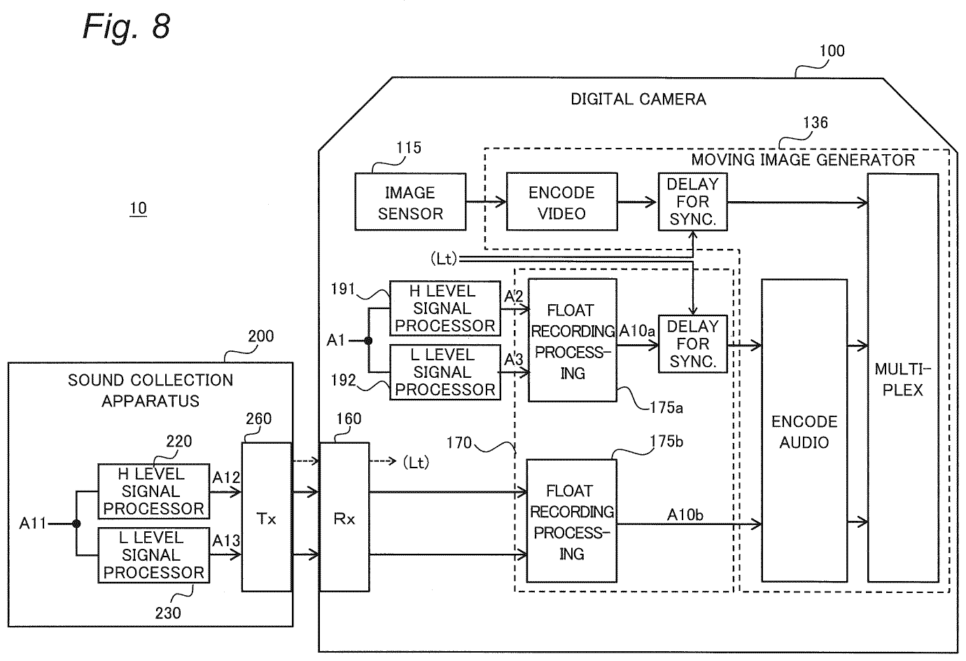

Hereinafter, a second embodiment of the present disclosure will be described with reference to FIG. 8. In the first embodiment, the imaging system 10 in which float recording by an internal configuration and float recording by the external sound collection apparatus 200 are switched is described. In the second embodiment, the imaging system 10 that performs such a plurality of systems of float recording simultaneously in parallel will be described.

Hereinafter, the imaging system 10 and the digital camera 100 according to the present embodiment will be described by appropriately omitting description of a configuration and operation similar to those of the imaging system 10 and the digital camera 100 according to the first embodiment.

FIG. 8 is a diagram for describing the imaging system 10 according to the second embodiment. For example, the imaging system 10 of the present embodiment includes a plurality of float recording processors 175a and 175b in the digital camera 100 as illustrated in FIG. 8, in a configuration similar to that of the imaging system 10 of the first embodiment. Each of the float recording processors 175a and 175b is configured similarly to the float recording processor 175 (FIG. 3) of the first embodiment, for example.

In the present system 10, the digital camera 100 inputs the audio signals A2 and A3 of an internal configuration to the first float recording processor 175a, and inputs the audio signals A12 and A13 of the sound collection apparatus 200 to the second float recording processor 175b, for example.

For example, in the first float recording processor 175a, gain information of each of the signal processors 191 and 192 of the digital camera 100 is set, similarly to Step S6 of the float recording setting operation (FIG. 5) in the first embodiment. In accordance with such setting, the first float recording processor 175a performs float recording processing on the input audio signals A2 and A3, and generates audio data A10a of a float recording result by a sound collecting means of an internal configuration.

Similarly to Step S7 in the float recording setting operation (FIG. 5) in the first embodiment, gain information of each of the signal processors 220 and 230 of the sound collection apparatus 200 is set in the second float recording processor 175b. According to such setting, the second float recording processor 175b performs float recording processing on the input audio signals A12 and A13, and generates audio data A10b of a float recording result by a sound collecting means of an external configuration such as the sound collection apparatus 200.

The digital camera 100 according to the present embodiment synchronizes the audio data A10a and A10b of such two systems of float recording results to generate a moving image file including both as sounds of different channels. For example, the controller 135 of the digital camera 100 acquires latency information Lt of the connected sound collection apparatus 200. Such processing is performed similarly to Step S4 of the setting operation (FIG. 5) of the first embodiment, for example.

Furthermore, the controller 135 sets the latency information Lt in the audio processing engine 170, and delays the audio data A10a of the first float recording processor 175a by a delay period of the latency information Lt to synchronize the audio data A10a with the audio data A10b of the second float recording processor 175b, for example. For example, the moving image generator 136 performs audio encoding on two systems of the audio data A10a and A10b synchronized in this way by a predetermined method (for example, LPCM).

In the digital camera 100 according to the present embodiment, the moving image generator 136 performs video encoding by a predetermined method (for example, H.264/H.265) on image data sequentially generated by the image sensor 115 at the time of moving image shooting, for example. Similarly to the audio data A10a of the first float recording processor 175a, the moving image generator 136 generates a moving image file by delaying such moving image data by a delay period of the latency information Lt, synchronizing the moving image data with the audio data A10a and A10b, and performing multiplexing of associating them with each other.

Hereinafter, according to the operation of the present system 10 described above, it is possible to generate a moving image file including audio data of a plurality of systems by simultaneously performing float recording in parallel for a plurality of systems of sound collecting means inside and outside the digital camera 100. At this time, by acquiring the latency information Lt of the sound collection apparatus 200 by the digital camera 100, it is possible to achieve synchronization between the audio data A10a and A10b of a plurality of systems and synchronization with video data of an imaging result in consideration of a communication delay of the sound collection apparatus 200.

In the above description, the operation example of simultaneously generating the audio data A10a and A10b of two systems in the imaging system 10 is described. The present system 10 is not particularly limited to two systems, and may generate three or more systems of the audio data A10a and A10b. For a shooting environment of the digital camera 100, sometimes sound collection may be performed simultaneously by a plurality of systems of sound collecting means such as a plurality of external microphones.

For example, an ambient microphone may be arranged at a position away from a subject for an environmental sound, or a shotgun microphone may be directed to a subject to collect both an environmental sound and voice from the subject. A boom microphone may be directed from above a subject, or a pin microphone may be arranged on a subject. The present system 10 may collectively perform float recording on a plurality of sound collecting means by the digital camera 100, for example.

For example, in the present system 10, the digital camera 100 may include three or more of the float recording processors 175a to 175b, and may include a plurality of the second float recording processors 175b corresponding to a plurality of the sound collection apparatuses 200. In such a case, the digital camera 100 of the present embodiment can acquire the latency information Lt of each of the sound collection apparatuses 200 and perform synchronization between audio data and video data in accordance with a longest delay period in a similar manner to that described above, for example.

As described above, in the present embodiment, the digital camera 100 further includes the moving image generator 136 that generates a moving image file by associating image data with the first and second audio data A10a and A10b. The audio processing engine 170 synchronously generates the first audio data A10a and the second audio data A10b based on latency information of the sound collection apparatus 200. By this, moving image shooting can be performed by using sound collecting means for float recording inside and outside the digital camera 100 simultaneously and in parallel, and float recording can be easily used in moving image shooting.

### Other Embodiments

As described above, the first and the second embodiments are described as examples of the technique disclosed in the present application. However, the technique in the present disclosure is not limited to this, and is also applicable to an embodiment in which changes, replacements, additions, omissions, and the like are appropriately made. Further, the constituent elements described in the above-described embodiment can also be combined to form a new embodiment. In view of the above, other embodiments will be exemplified below.

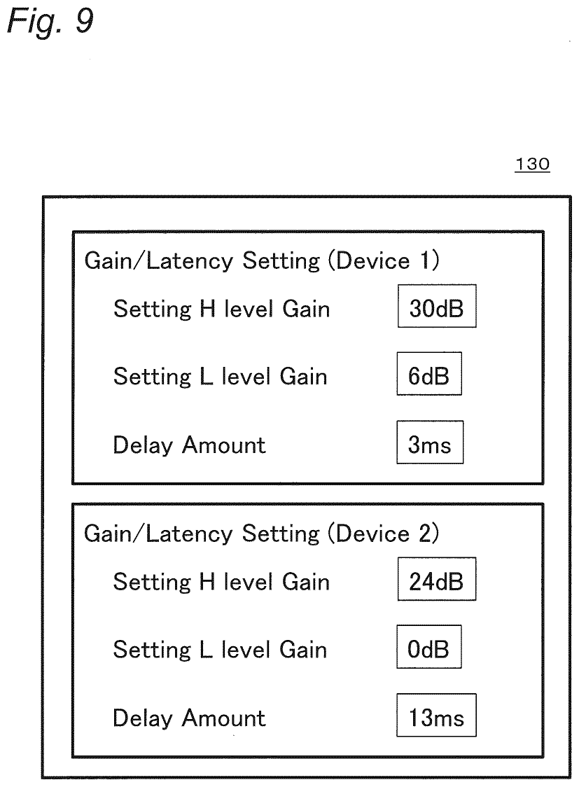

In the first embodiment, an operation example in which the digital camera 100 receives gain information and the like from the sound collection apparatus 200 is described, but the present embodiment is not limited to this. In the present embodiment, gain information and the like may be acquired not only from the sound collection apparatus 200 but also via user operation. Such a variation will be described with reference to FIG. 9.

FIG. 9 illustrates a display example of the display monitor 130 in the digital camera 100 according to the variation. For example, the digital camera 100 of the present embodiment displays an operation screen on which the gain Gc of the H level signal processor 220 of the sound collection apparatus 200 and the gain Gd of the L level signal processor 230 can be changed on the display monitor 130, and receives user operation of the operation screen on the user interface 150. In the digital camera 100 of the present embodiment, such an operation screen may enable input of latency information for delay correction of the sound collection apparatus 200.

In the example of FIG. 9, the gains Gc and Gd and a delay amount are displayed in a manner numerically changeable. For example, the digital camera 100 may display an option for a delay amount or the gains Gc and Gd for each model of the sound collection apparatus 200. Alternatively, the digital camera 100 may display a model of the sound collection apparatus 200 as an option and receive user operation for the selection. The digital camera 100 according to the present embodiment may acquire gain information in accordance with input of various user operation as described above.

In the example of FIG. 9, an operation example in which two of the sound collection apparatuses 200 are used to perform float recording of each of them is illustrated. In this case, as exemplified in FIG. 9, a delay amount may be able to be input for each of the sound collection apparatuses 200. Alternatively, a delay amount between two of the sound collection apparatuses 200 may be able to be input. For example, the digital camera 100 may separately acquire a delay period of one of the sound collection apparatuses 200 and perform delay correction of another one of the sound collection apparatuses 200 from a delay amount of user input.

In the digital camera 100 of the present embodiment, in the delay correction as described above, a delay amount may be adjusted from various factors other than communication with the sound collection apparatus 200, for example. The operation screen of the digital camera 100 may receive user input of gain information and latency information of one of the sound collection apparatus 200, or may be for three or more of the sound collection apparatuses 200, without particular limitation to two of the sound collection apparatuses 200.

In the first embodiment described above, the operation example in which a plurality of systems of float recording inside and outside the digital camera 100 are switched and performed is described, and in the second embodiment, the operation example in which such a plurality of systems of float recording are simultaneously performed in parallel is described. The digital camera 100 according to the present embodiment may be configured to be able to select, by user operation, operation of switching between a plurality of systems of float recording as in the first embodiment and operation of simultaneously performing a plurality of systems of float recording in parallel as in the second embodiment. The digital camera 100 according to the present embodiment may prompt the user to make the above selection in a setting menu, and receive such user operation in the user interface 150, for example.

In the above embodiments, the example in which the sound collection apparatus 200 and the digital camera 100 perform BLE communication to realize float recording is described. In the present embodiment, the sound collection apparatus 200 and the digital camera 100 may realize float recording by wireless communication or wired communication other than BLE communication. For example, the sound collection apparatus 200 according to the present embodiment may perform USB standard wired communication with the digital camera 100 to perform data transmission for the audio signals A12 and A13.

In the above embodiments, the sound collection apparatus 200 including two of the signal processors 220 and 230 for input sound of one channel is described. The sound collection apparatus 200 according to the present embodiment may include three or more signal processors for input sound of one channel. In the sound collection apparatus 200 of the present embodiment, each gain may be set so that a dynamic range is shared among three or more signal processors. The digital camera 100 of the present embodiment may generate audio data of a float format so as to use sound accurately collected in each audio signal based on an audio signal of a sound collection result of each of the three or more signal processors. The digital camera 100 according to the present embodiment may include three or more of the signal processors 191 to 192 for input sound of one channel.

In the above embodiments, the example in which the sound collection apparatus 200 does not perform float recording processing is described. In the present embodiment, the sound collection apparatus 200 may perform float recording processing, and may further include a configuration such as an arithmetic circuit that realizes such arithmetic processing. Alternatively, the sound collection apparatus 200 may further include a recording function different from float recording. Even in such an exemplary case, the sound collection apparatus 200 can transmit the audio signals A12 and A13 to the digital camera 100 as in the first embodiment, so that the digital camera 100 can also perform float recording processing, and calculation load of the sound collection apparatus 200 can be reduced, for example. Similarly to the above embodiment, the sound collection apparatus 200 according to the present embodiment allows audio data showing a sound collection result in a float form to be obtained easily by using the sound collection apparatus 200 and the digital camera 100.

In the above embodiments, the example in which the sound collection apparatus 200 transmits data of the audio signals A12 and A13 to the digital camera 100, and the digital camera 100 performs float recording processing. In the present embodiment, the sound collection apparatus 200 may perform data transmission to an audio processing device such as various electronic devices other than an imaging apparatus such as the digital camera 100. In the present embodiment, such an audio processing device may perform float recording processing or may include the signal processors 191 to 192 for float recording, similarly to the digital camera 100 of the first embodiment. The audio processing device according to the present embodiment may be an audio recorder or a microphone device.

That is, the sound processing apparatus according to the present embodiment includes the sound input interface for inputting the first input sound, the first signal processor that performs the first amplification conversion on the first input sound to generate the first audio signal, the second signal processor that performs the second amplification conversion, which is different from the first amplification conversion, on the first input sound to generate the second audio signal, the audio processor that combines the first and second audio signals to generate the first audio data indicating a sound collection result of the first input sound in a predetermined data format, and the receiver that establishes communication connection with an external sound collection apparatus and receives the third and fourth audio signals from the sound collection apparatus. The third audio signal indicates a result of the third amplification conversion performed on the second input sound in the sound collection apparatus. The fourth audio signal indicates a result of the fourth amplification conversion performed on the second input sound in the sound collection apparatus, the fourth amplification conversion being different from the third amplification conversion. The audio processor generates the second audio data indicating a sound collection result of the second input sound in a predetermined data format by combining the third and fourth audio signals received from the receiver. By the above, in the present embodiment, it is possible to easily obtain audio data showing a sound collection result in a predetermined format such as a float format by using the sound collection apparatus and the audio processing device.

In the above embodiments, a float format is exemplified as an example of the predetermined data format. In the present embodiment, the predetermined data format is not necessarily limited to a float format, and may be various data formats in which each resolution can be kept between sounds having a sound volume significantly different from a range of resolution of sound, for example.

In the above embodiments, the memory card 142 is exemplified as a recording medium, and the card slot 140 is exemplified as a recorder of the digital camera 100, but the recorder is not limited to this. In the present embodiment, the recording medium is not limited to a memory card, and may be e.g. an external storage device such as an SSD drive. The digital camera 100 according to the present embodiment may upload a moving image file or the like to a cloud server or the like via the communication module 160, for example.

In the above embodiments, the digital camera 100 including the optical system 110 and the driver 112 is exemplified. The imaging apparatus of the present embodiment does not need to include the optical system 110 or the driver 112, and may be an interchangeable lens type camera, for example.

In the above embodiments, the digital camera is described as an example of the imaging apparatus, but the present disclosure is not limited to this. The imaging apparatus of the present disclosure may be an electronic apparatus having an image capturing function (e.g., a video camera, a smartphone, a tablet terminal, or the like).

### Aspect Examples

Hereinafter, various aspects of the present disclosure will be exemplified.

A first aspect according to the present disclosure is an imaging apparatus including: an image sensor that captures a subject image to generate image data; a sound input interface that inputs a first input sound; a first signal processor that performs first amplification conversion on the first input sound to generate a first audio signal; a second signal processor that performs second amplification conversion on the first input sound to generate a second audio signal, the second amplification conversion being different from the first amplification conversion; an audio processor that combines the first and second audio signals to generate first audio data indicating a sound collection result of the first input sound in a predetermined data format; and a receiver that connects with an external sound collection apparatus for communication to receive third and fourth audio signals from the sound collection apparatus. The third audio signal indicates a result of third amplification conversion performed on second input sound in the sound collection apparatus. The fourth audio signal indicates a result of fourth amplification conversion performed on the second input sound in the sound collection apparatus, the fourth amplification conversion being different from the third amplification conversion. The audio processor combines the third and fourth audio signals received from the receiver to generate second audio data indicating a sound collection result of the second input sound in the predetermined data format.

A second aspect is the imaging apparatus according to the first aspect, further including a moving image generator that generates a moving image file by associating the image data with the first or second audio data. The audio processor selectively generates one of the first audio data or the second audio data.

A third aspect is the imaging apparatus according to the first or second aspect, further including a moving image generator that generates a moving image file by associating the image data with the first and second audio data. The audio processor generates the first audio data and the second audio data in synchronization with each other, based on latency information of the sound collection apparatus.

A fourth aspect is the imaging apparatus according to any one of the first to third aspects, further including a controller that detects communication connection between the sound collection apparatus and the receiver to control the audio processor. The controller controls the audio processor to generate the second audio data, based on the third and fourth audio signals, when the sound collection apparatus connected to the receiver is able to transmit the third and fourth audio signals.

A fifth aspect is the imaging apparatus according to the fourth aspect, wherein the controller controls the audio processor to generate the first audio data, based on the first and second audio signals, when the sound collection apparatus is not connected to the receiver.

A sixth aspect is the imaging apparatus according to the fourth or fifth aspect, wherein when the sound collection apparatus connected to the receiver is not able to transmit the third and fourth audio signals, the controller controls the audio processor to generate third audio data indicating a sound collection result of the second input sound in a format different from the predetermined data format, based on a fifth audio signal received by the receiver from the sound collection apparatus.

A seventh aspect is the imaging apparatus according to any one of the first to sixth aspects, wherein the first signal processor includes: a first amplifier that amplifies the first input sound with a first gain; and a first A/D converter that performs A/D conversion on an amplification result of the first amplifier to generate the first audio signal. The second signal processor includes: a second amplifier that amplifies the first input sound with a second gain smaller than the first gain; and a second A/D converter that performs A/D conversion on an amplification result of the second amplifier to generate the second audio signal.

An eighth aspect is the imaging apparatus according to any one of the first to seventh aspects, wherein the third amplification conversion amplifies the second input sound in a third amplifier and performs A/D conversion on the amplified second input sound to generate the third audio signal, the third amplifier having a third gain. The fourth amplification conversion amplifies the second input sound in a fourth amplifier and performs A/D conversion on the amplified second input sound to generate the fourth audio signal, the fourth amplifier having a fourth gain smaller than the third gain.

A ninth aspect is the imaging apparatus according to any one of the first to eighth aspects, wherein the audio processor acquires gain information set in the third and fourth amplifiers in the sound collection apparatus, and generates the second audio data from the third and fourth audio signals by using the gain information.

A tenth aspect is the imaging apparatus according to any one of the first to ninth aspects, wherein the predetermined data format is a float format having a significand part and an exponent par. The audio processor generates the first audio data to increase the exponent part more as a sound volume of the first input sound is larger. The audio processor may generate the second audio data to increase the exponent part more as a sound volume of the second input sound is larger.

As described above, the embodiments are described as the exemplification of the technique in the present disclosure. To that end, the accompanying drawings and the detailed description are provided.

Therefore, among the components described in the accompanying drawings and the detailed description, not only the component essential for solving the problem, but also the component not essential for solving the problem may be included in order to exemplify the above technique. Therefore, it should not be certified that these non-essential components are essential immediately because these non-essential components are described in the accompanying drawings and the detailed description.

In addition, since the above embodiment is for exemplifying the technique in the present disclosure, various changes, substitutions, additions, omissions, and the like can be made within the scope of the claims or the equivalent thereof.

The present disclosure is applicable to an imaging apparatus that receives an audio signal from a sound collection apparatus, a sound collection apparatus, and an imaging system including these apparatuses.

1. An imaging apparatus comprising:
an image sensor that captures a subject image to generate image data;
a sound input interface that inputs a first input sound;
a first signal processor that performs first amplification conversion on the first input sound to generate a first audio signal;
a second signal processor that performs second amplification conversion on the first input sound to generate a second audio signal, the second amplification conversion being different from the first amplification conversion;
an audio processor that combines the first and second audio signals to generate first audio data indicating a sound collection result of the first input sound in a predetermined data format; and
a receiver that connects with an external sound collection apparatus for communication to receive third and fourth audio signals from the sound collection apparatus, wherein
the third audio signal indicates a result of third amplification conversion performed on second input sound in the sound collection apparatus,
the fourth audio signal indicates a result of fourth amplification conversion performed on the second input sound in the sound collection apparatus, the fourth amplification conversion being different from the third amplification conversion, and
the audio processor combines the third and fourth audio signals received from the receiver to generate second audio data indicating a sound collection result of the second input sound in the predetermined data format.

2. The imaging apparatus according to claim 1, further comprising a moving image generator that generates a moving image file by associating the image data with the first or second audio data, wherein
the audio processor selectively generates one of the first audio data or the second audio data.

3. The imaging apparatus according to claim 1, further comprising a moving image generator that generates a moving image file by associating the image data with the first and second audio data, wherein
the audio processor generates the first audio data and the second audio data in synchronization with each other, based on latency information of the sound collection apparatus.

4. The imaging apparatus according to claim 1, further comprising a controller that detects communication connection between the sound collection apparatus and the receiver to control the audio processor, wherein
the controller controls the audio processor to generate the second audio data, based on the third and fourth audio signals, when the sound collection apparatus connected to the receiver is able to transmit the third and fourth audio signals.

5. The imaging apparatus according to claim 4, wherein the controller controls the audio processor to generate the first audio data, based on the first and second audio signals, when the sound collection apparatus is not connected to the receiver.

6. The imaging apparatus according to claim 4, wherein when the sound collection apparatus connected to the receiver is not able to transmit the third and fourth audio signals, the controller controls the audio processor to generate third audio data indicating a sound collection result of the second input sound in a format different from the predetermined data format, based on a fifth audio signal received by the receiver from the sound collection apparatus.

7. The imaging apparatus according to claim 1, wherein
the first signal processor includes: a first amplifier that amplifies the first input sound with a first gain; and a first A/D converter that performs A/D conversion on an amplification result of the first amplifier to generate the first audio signal, and
the second signal processor includes: a second amplifier that amplifies the first input sound with a second gain smaller than the first gain; and a second A/D converter that performs A/D conversion on an amplification result of the second amplifier to generate the second audio signal.

8. The imaging apparatus according to claim 1, wherein
the third amplification conversion amplifies the second input sound in a third amplifier and performs A/D conversion on the amplified second input sound to generate the third audio signal, the third amplifier having a third gain, and
the fourth amplification conversion amplifies the second input sound in a fourth amplifier and performs A/D conversion on the amplified second input sound to generate the fourth audio signal, the fourth amplifier having a fourth gain smaller than the third gain.

9. The imaging apparatus according to claim 8, wherein
the audio processor
acquires gain information set in the third and fourth amplifiers in the sound collection apparatus, and
generates the second audio data from the third and fourth audio signals by using the gain information.

10. The imaging apparatus according to claim 1, wherein
the predetermined data format is a float format having a significand part and an exponent part, and
the audio processor generates the first audio data to increase the exponent part more as a sound volume of the first input sound is larger.
